(19) United States
(12) Patent Application Publication
(10) Pub. No.: US 2017/0113659 A1
(43) Pub. Date: Apr. 27, 2017

(54) Inner Wheel Cleaning Pad

(71) Applicant: Ringbrothers, LLC, Spring Green, WI (US)

(72) Inventors: James Alan Ring, Spring Green, WI (US); Michael Daniel Ring, Spring Green, WI (US); Matthew Edward Moseman, Saulk City, WI (US)

(21) Appl. No.: 15/298,930

(22) Filed: Oct. 20, 2016

Related U.S. Application Data
(63) Continuation-in-part of application No. 29/581,289, filed on Oct. 18, 2016.
(60) Provisional application No. 62/245,418, filed on Oct. 23, 2015.

(51) Int. Cl. B60S 1/68; B08B 3/04; B08B 1/00

(52) U.S. Cl. CPC B60S 1/685; B08B 1/001; B08B 3/04

(57) ABSTRACT

A cleaning pad cleans an inner wheel surface of a vehicle wheel. The cleaning pad has a base surface, an upper surface, and a lateral portion extending between the base surface and upper surface. The cleaning pad comprises a compressible material and is configured to install relative to the wheel. Upon installation, base surface engages with the inner surface of the wheel and the upper surface engages with the with the stationary mechanism. The upper surface of the installed cleaning pad remains in a fixed position relative to the stationary mechanism as the wheel rotates such that the base surface can apply pressure to, and clean the inner wheel surface.

### RELATED APPLICATIONS

This application claims the priority benefit of U.S. Provisional Patent Application No. 62/245,418, filed Oct. 23, 2016, titled Inner Wheel Cleaning Pad, which is hereby incorporated by reference in its entirety. This application is also a continuation-in-part of U.S. Design patent application No. 29/581,289, filed on Oct. 18, 2016, titled “Cleaning Pads,” which is whereby incorporated by reference in its entirety.

### TECHNICAL FIELD

The present disclosure generally relates to a cleaning pad used to clean the inner surface of a wheel. More specifically, the present disclosure relates to a cleaning pad that cleans the inner surface of a wheel by utilizing the rotational motion of a wheel.

### BACKGROUND

Cleaning the inner surfaces of a vehicle wheel can be a difficult task. Standard vehicle washing procedures are typically primarily directed to exterior vehicle surfaces, thereby leaving the inner wheel surfaces relatively unscrubbed, unwashed, and uncleaned. Accordingly, to clean the inner surfaces of a vehicle wheel, one will typically invoke separate tasks specifically devoted to cleaning these inner surfaces.

The inner surfaces of vehicle wheels are often very difficult to clean because they are typically obstructed by structural components of the wheel, such as wheel spokes or the like. These structural components provide very narrow clearings which limits the size of the cleaning devices that can be used for the task. Moreover, the obtrusive structural components limit the amount of surface area that can be reached and cleaned.

### SUMMARY

The present disclosure presents examples of a cleaning pad that cleans an inner wheel surface of a vehicle wheel. In one example, the cleaning pad includes a base surface, an upper surface, and a lateral portion extending between the base surface and upper surface. The cleaning pad comprises a compressible material and is configured to install relative to the wheel. Upon installation, base surface engages with the inner surface of the wheel and the upper surface engages with the with the stationary mechanism. The upper surface of the installed cleaning pad remains in a fixed position relative to the stationary mechanism as the wheel rotates such that the base surface can apply pressure to, and clean the inner wheel surface.

The cleaning pad is configured to be placed in a wheel cavity between the inner wheel surface and an inner wheel stationary mechanism. The shape and rigidity of the cleaning pad assist in creating sufficient contact between the base surface of the cleaning pad and an inner wheel surface. Once placed in the wheel cavity between the inner wheel surface and inner wheel stationary mechanism, the base surface of the cleaning pad acts as a scrubbing mechanism to rid the inner wheel surface of residue including, but not limited to dirt, dust, debris, grime, stains, rust, oil, or other unsightly material that can accrue on the surface of a vehicle wheel. To facilitate cleaning, the cleaning pad may be soaked with water or exposed to soap or any other type of cleaning agent.

Upon placing the cleaning pad in the inner wheel cavity, the vehicle wheel can be rotated in the course of its usual operation. For example, the vehicle can be operated to move forward or backward over the length of one or more full rotations of the vehicle wheel. During this rotation, the installed cleaning pad will fix in place. For example, the cleaning pad may begin to move with the wheel until it contacts an inner wheel stationary mechanism that inhibits, or even prevents the cleaning pad from further movement with the wheel. In this way, as the wheel continues to rotate, the base surface of the cleaning pad (now fixed in place) is exposed to, and presses against, a portion of the inner wheel surface (e.g., some, all, or substantially all of the inner wheel surface). The pressure of base surface of the cleaning pad on the inner wheel surface as the wheel rotates can facilitate cleaning of the inner wheel surface. Optionally, the wheel can be rotated forward or backward to perform multiple scrubbing iterations. After completion, the cleaning pad can be removed from the wheel cavity and the cleaning process can be restarted on another wheel. Additionally and/or alternatively, multiple pads can be used on multiple wheels of the vehicle at the same time, such that moving the vehicle forward and backward results in the simultaneous cleaning of multiple wheels.

Some examples described herein include kits that comprise two or more cleaning pads (e.g., one or more of the cleaning pads described herein) packaged together. For example, some kits may include four cleaning pads so that a vehicle having four wheels can be cleaned with a single manipulation of the vehicle. In some examples, the kits may include a cleaning solution, such as a soap or cleanser that is particularly suited for cleaning an inner wheel surface.

The present disclosure also presents examples of methods for cleaning the inner surface of a vehicle wheel. For example, some methods include using the cleaning pads described herein to clean a vehicle wheel. Such methods include compressing the cleaning pad so that the pad fits through an orifice (e.g., between spokes or structures on a wheel) of a wheel and placing the cleaning pad in place with a base surface (or cleaning surface) in contact with the inner wheel surface, and an upper surface in contact with a stationary mechanism. In this manner, the stationary mechanism will hold the cleaning pad (e.g., via the upper surface) so that the cleaning pad remains stationary even as the wheel rotates in the course of its usual operation. With the cleaning surface in contact with the inner surface of the wheel, the method can the rotate the wheel (e.g., by moving the vehicle forward or backward) to clean the contacted surface.

### BRIEF DESCRIPTION OF THE DRAWINGS

FIG. 1 is an isometric view showing the top of a cleaning pad with a modified cone configuration in accordance with examples described herein.

FIG. 2 is an isometric view showing the bottom surface of a cleaning pad with a modified cone configuration in accordance with examples described herein.

FIG. 3A is an isometric view showing an exemplary cleaning pad having a modified cone configuration with one possible textured surface.

FIG. 3B shows the textured bottom surface of the cleaning pad of FIG. 3A.

FIG. 4 is an isometric view of a cleaning pad having an elongated triangle configuration and a rigid spine member in accordance with examples described herein.

FIG. 5 is an isometric view of a cleaning pad having an elongated star shaped configuration in accordance with examples described herein.

FIG. 6 is an isometric view showing internal components in broken line of a cleaning pad with an elongated triangle configuration with a rigid spine member located inside the cleaning pad in accordance with examples described herein.

FIG. 7 is an isometric view of an example of another cleaning pad having an elongated triangle configuration with ridges and grooves located on variable base surfaces in accordance with examples described herein.

FIG. 8 is an isometric view of a cleaning pad with a modified cone configuration and additional extended protrusions located on the tapered lateral portion in accordance with examples described herein.

FIG. 9 is an isometric view of a cleaning pad having an elongated triangle configuration with one potential groove pattern in accordance with examples described herein.

FIG. 10 is an isometric view of another cleaning pad having an elongated triangle configuration with an additional groove pattern in accordance with examples described herein.

FIG. 11 is an isometric view of a cleaning pad having an elongated pie-shaped configuration with a potential ridge or groove pattern in accordance with examples described herein.

FIG. 12 is an isometric view of a cleaning pad having an elongated gear-shaped pattern in accordance with examples described herein.

FIG. 13 shows a textured surface of a cleaning pad in accordance with examples described herein.

FIG. 14A shows an isometric view of a cleaning pad with a pseudo-triangular shaped cross section and a textured lower surface in accordance with examples described herein.

FIG. 14B shows another isometric view of the cleaning pad of FIG. 14A from a bottom vantage point.

FIG. 15A shows an isometric view of another cleaning with a pseudo-triangular shaped cross section and a textured lower surface in accordance with examples described herein.

FIG. 15B shows another isometric view of the cleaning pad of FIG. 15A from a bottom vantage point.

FIG. 16 shows an example of a vehicle wheel with an inner wheel surface that can be cleaned by examples of the cleaning pads described herein.

FIG. 17 shows a cleaning pad prior to installation into a wheel cavity in accordance with examples described herein.

FIG. 18 shows a cleaning pad installed in a wheel cavity in accordance with examples described herein.

FIG. 19 is a flow diagram of a method in accordance with examples described herein.

### DETAILED DESCRIPTION

The present disclosure describes examples of a cleaning pad used to clean the inner surface of a vehicle wheel and methods or techniques for using such cleaning pads to clean inner vehicle wheel surfaces. For example, the present disclosure presents embodiments of a cleaning pad that is configured to be positioned inside of a vehicle wheel such that the pad remains in place as the wheel rotates as it does in the usual course of operation. In such a configuration, a cleaning surface of the cleaning pad (which may be doused with soap, water, and/or cleaning substances) contacts and/or applies pressure on an inner surface of the vehicle wheel. As the wheel rotates about the cleaning pad (e.g., by moving the vehicle forward or rearward), the cleaning surface cleans the inner wheel surface that it contacts. The cleaning pad is configured so that it can compress to fit between the structures of the wheel (e.g., between adjacent spokes), while still being positionable to apply pressure on the inner wheel cleaning surface, and to remain in place as the wheel rotates. After completion, the cleaning pad may be washed and reused on additional vehicle wheels.

The presently described technology provides several advantages over other techniques for cleaning the inner surfaces of a vehicle wheel. Current techniques for cleaning inner wheel surfaces involve intensive, time consuming practices that can be difficult, expensive, or potentially damaging to the wheel. Moreover, many techniques involve a user reaching into the narrow spaces of an inner wheel, which can be very difficult and painful, even for the most dexterous of users.

For example, some inner wheel cleaning techniques involve a washer inserting hands or fingers through a small orifice located between adjacent structures (e.g., spokes) on the outer surface of the wheel. In such a technique, the washer will bend their wrist and fingers into various directions and positions, many of which can be uncomfortable or painful, in an effort to scrub or clean small portions of the wheel. Such a practice can result in cuts or bruises on the wearer's hands and/or wrist. This practice can also be inefficient, as many portions of the inner wheel surface may be unreachable by a washer's hands, thereby going uncleaned.

Other inner wheel cleaning techniques employ devices so that a wearer need not insert body parts (e.g., fingers, hands, wrists, arms, etc.) through the orifices on a wheel, thereby exposing the body parts to stress, discomfort, or injury. For example, one technique employs a brush and handle device to clean the inner wheel surface. Here, a washer may grasp the brush handle and direct the brush end through the wheel orifice and scrub or otherwise clean the inner wheel surface. This technique may reduce or limit the physical harm on the washer because as it alleviates the need for a washer to insert a hand into the wheel well where it can be cut by sharp metal ends. Still, a washer using a brush may experience difficulty establishing contact or pressure sufficient to satisfactorily clean the wheel surface. Moreover, the bristles on the brush can be overly abrasive, and may cause scratching or damage to the inner surface of the wheel.

The presently disclosed cleaning pads and methods provide several benefits, advantages, and improvements over other techniques. The described technology allows for the inner wheel surfaces to be cleaned quickly and thoroughly, without damaging or harming the inner wheel surface, and without exposing a washer's body parts to discomforting positions.

The cleaning pads described herein may come in various shapes, sizes, and configurations to best suit the task at hand. Factors that may affect the design of the cleaning pad include, but are not limited to, the size of the wheel to be cleaned, the amount of dirt accumulated on the wheel, the size of the orifices of the wheel, and the equipment and configuration associated with the wheel itself (e.g., the location of a stationary mechanism, the shape and position of the wheel spokes, etc.).

The cleaning pads and techniques described herein may be used by an individual consumer in regular car maintenance. Additionally, the cleaning pads may be used in the commercial vehicle washing industry or in the auto show industry. The cleaning pads can also be used on a variety of vehicle wheels including, but not limited to, all-terrain vehicle wheels, motorcycle wheels, bicycle wheels, large industrial machine wheels, and the like.

The cleaning pad can be made of a compressible material capable of being compressed by an able bodied adult with a single hand without requiring undue exertion or strength. In some examples, the compressible material will be configured so that the cleaning pad can be compressible to a compressed size small enough to be inserted through an orifice in a wheel (e.g., through a location between two wheel spokes). The cleaning pad can be configured so that a typical hand squeeze force will be sufficient (or more than sufficient) to compress the pad to the compressed size (e.g., the size small enough to fit the pad through the orifice). The typical hand squeeze force is a force level that is generally achievable by a typical able-bodied adult with a single hand without requiring undue exertion or strength. A person of ordinary skill in the art will understand when a compressible material has properties that require forces greater than the typical hand squeeze force to compress the material to a compressed state. In some embodiments, however, depending on the intended use of the cleaning pad, the pad may comprise materials that are denser, or more difficult to compress than by use of a typical hand squeeze force.

In some examples, the cleaning pad will include a rigid spine member designed to retain the original shape of the cleaning pad and provide sufficient contact with adjacent surfaces. To install the cleaning pad, a washer, or user will compress the cleaning pad and place it inside the wheel cavity in contact with an inner wheel surface to be cleaned (the washer may first immerse the cleaning pad in a cleaning fluid such as soap, water, other cleaning substances, and/or combinations thereof). Upon placement into the wheel cavity, the cleaning pad will expand to contact all or a portion of the inner wheel surface.

The user can then rotate the wheel in a clockwise or counterclockwise direction. The rotation can be performed, for example, in the course of the typical operation of the wheel. For example, the vehicle can be moved forward or rearward, thereby rotating the wheel. The wheel rotation thereby induces the cleaning pad to scrub the inner wheel surface that it is in contact with. This results in minimal manual labor required by the user and the chances of injury or harm stemming from sharp components in the wheel cavity being significantly reduced. In some examples, the cleaning pad can be reused on multiple wheels thereby increasing efficiency and decreasing cleaning time.

As noted, the present disclosure provides examples of cleaning pads that take on a variety of shapes and configurations. Depending on the intended application and the wheel being configured, the cleaning pad can employ different shapes, sizes, surface structures, and material properties. In some embodiments, for example, the cleaning pad will have a shape that has a base portion that is wider, deeper, or otherwise larger in at least one dimension than at a surface opposite the base surface. That is, the cleaning pad can have a wider base surface, a narrower upper surface opposite the base surface, and a tapered side portion.

For ease of reference throughout this application, the portion of the cleaning pad (e.g., the surface, edge, point, vertex, etc.) opposite the base surface will be referred to as an “upper surface,” even though in some configurations, the portion opposite the base surface may not form a flat or clearly defined surface. For example, in some forms, the surface opposite the base surface may form an edge (e.g., where the cross section forms a vertex of a triangle or other polygon), a point (e.g., where the shape forms a cone or similar shape), a nose or rounded edge (e.g., where the shape of the cleaning pad forms a rounded edge or tip), or it may be formed primarily by a junction between two surfaces of the tapered side portion. Thus, this portion opposite the base surface may not define a flat surface, or a surface of any form. And in some forms, the portion opposite the base surface may not be defined by visibly distinguishable boundaries. Nevertheless, this application will refer to this portion as an upper surface.

As mentioned above, in some examples, the base surface of the cleaning pad is larger, has a larger surface area, or is at least larger in one dimension than that of the upper surface of the cleaning pad. Cleaning pads having such a configuration—i.e., shapes that are narrower or thinner in the region closest to the stationary mechanism of the wheel (e.g., the brake caliper or dust shield), and wider at the portion closest to the inner wheel surface—may be able to situate or fix in place within the inner wheel, and provide significant force and pressure on the inner wheel surface. These cleaning pads may also be able to engage with the inner surface of the wheel in a manner that allows the pad to provide a pressure against the wheel sufficient to remove dirt and debris. Further, the cleaning pads may have a sufficiently large area that is in contact with the inner wheel surface so that the surface can be adequately cleaned.

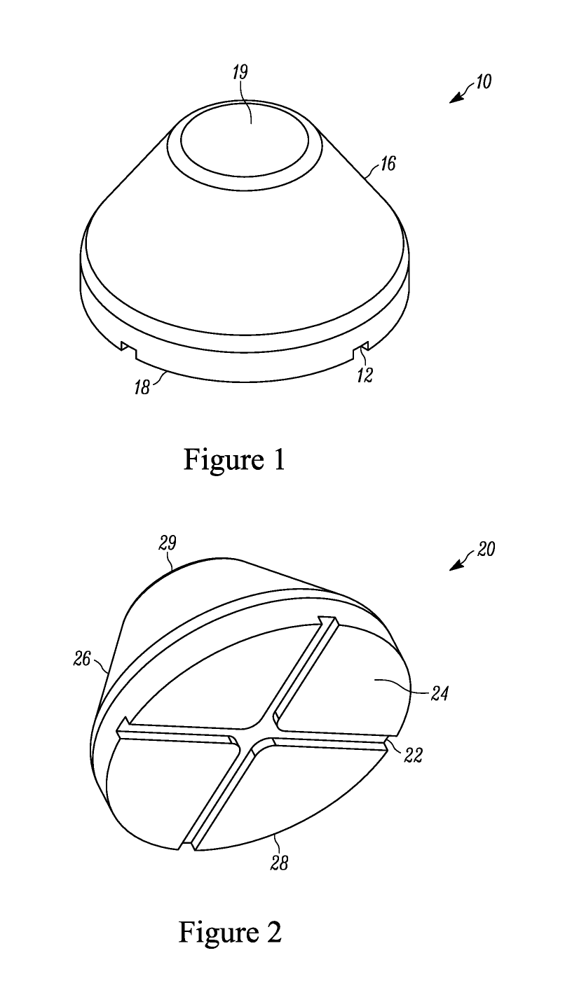

FIG. 1 shows an example of a cleaning pad 10 having a modified cone or “space-ship” shape or configuration. The modified cone shape of FIG. 1 consists of a base surface 18 having a base depth and base width, an upper surface 19 having an upper depth and upper width, and a tapered lateral portion 16 extending between the base surface 18 and upper surface 19. The tapered lateral portion 16 narrows in width, depth, and/or diameter along the height of the pad, moving from the base to the top.

In operation, this modified cone or “space-ship” configured cleaning pad 10 can be directed through an orifice on the exterior of a wheel rim. For example, the cleaning pad 10 can be compressed or squeezed so as to fit between the spokes of a wheel, and placed on the inner wheel surface. While this figure shows a modified cone or “space-ship” configuration, it should be understood that the shape of the cleaning pad 10 can take on other configurations, depending, for example, on the intended application of the pad, and/or the size, shape, and appearance of the wheel to be cleaned. For example, the cleaning pad 10 may have a cross section in the shape of a circle, rectangle, triangle, or star. The cleaning pad 10 may also come in larger and smaller sizes with varying lengths, widths, and heights.

Additionally, the surface of the cleaning pad 10 may have bumps, ridges, grooves, or cutout patterns to increase or decrease the level of pressure applied to the inner wheel surface. In another embodiment the cleaning pad 10 contains a rigid spine member which helps maintain the predetermined shape of the cleaning pad 10 when placed in contact with the wheel. This rigid spine member may be in the same or a different shape than the cleaning pad. The rigid spine member may also facilitate contact of hard to reach areas within the wheel cavity.

The base surface 18 is configured to clean an inner wheel surface. When the cleaning pad 10 is installed in the wheel cavity, the base surface 18 is configured to contact the inner wheel surface. In one embodiment the base surface 18 has a greater depth than that of the upper surface 19. That is, when installed in a wheel, the base surface 18 can span a greater portion of the depth of the wheel than the upper surface 19. In other aspects, the base surface 18 can be smaller or similar in depth to the upper surface 19. In yet another embodiment the base surface 18 and the upper surface 19 have depths that are generally the same.

Additionally, the base surface 18 can have a round shape, rectangular shape, triangular shape, or star shape. The base surface 18 may also have a width larger than that of the upper surface 19. A large width base surface helps ensure maximal contact between the base surface 18 and an inner wheel surface. A larger base surface also works in connection with the radial nature of the placement of the cleaning pad, as the base surface 18 is radially outward from the upper surface 19, and thus will have more space within the confines of the wheel to clean. In some aspects, the size of the base surface 18 may be smaller or generally the same as that of upper surface 19, depending on the particular configurations of the wheel that the cleaning pad is intended to operate in connection with.

The rounded base surface of the modified cone shape of FIG. 1 allows the cleaning pad 10 to install with respect to the wheel in a manner that inhibits the pad from snagging on spokes or other components that rotate with the wheel. Because the base surface 18 is round, it lacks significant corners or edges, which may be more likely to catch, snag, snare, or otherwise be displaced by a rotating wheel.

FIG. 1 also shows the upper surface 19 of the modified cone shaped cleaning pad 10. The upper surface 19 is configured to catch on an inner wheel stationary mechanism such as the brake caliper or dust shield. Once in contact with the inner wheel stationary mechanism, the upper surface 19 locks the cleaning pad in place. When the wheel begins to rotate the cleaning pad 10 remains stationary while the wheel rotates around it. As the wheel rotates, a substantial portion of the inner wheel surface contacts the base surface 18 of the cleaning pad 10. After one or more rotations the base surface 18 has removed residue located on the inner wheel surface. To ensure adequate residue removal however, the upper surface 19 must establish sufficient contact with the inner wheel stationary mechanism.

Once in contact with the inner wheel stationary mechanism, the upper surface 19 holds the cleaning pad 10 in place. While in use, shearing forces are applied to the cleaning pad 10 due to the interaction between the base surface 18 and inner wheel surface. In some examples, the upper surface 19 will include a second material, different from the base surface material, that resists shearing forces and tearing. For instance, the material of the upper surface 19 may have a higher density, may be stronger, more durable, more resilient, or more flexible than the base surface material. Further, the material of the upper surface 19 may be reinforced with structural elements such as wires or other elements to add strength to the material. Incorporation of the second material in the upper surface 19 inhibits degradation of the cleaning pad 10 around the upper surface 19. This helps establish sound contact between the upper surface 19 and the inner wheel stationary mechanism which results in improved cleaning functionality.

The upper surface 19 can be made of a sponge-like or foam material with additional strength or tear resistance capabilities. The upper surface 19 may also contain a pattern to assist in creating solid contact between the upper surface 19 and the inner wheel stationary mechanism. Additionally, the upper surface 19 may contain a textured surface 12. The textured surface 12 may contain a pattern of ridges, bumps, cutouts, or grooves. The textured surface 12 can increase the susceptibility of the upper surface 19 catching on an inner wheel stationary mechanism such as a brake caliper or dust shield.

In addition to being made of a different material than that of the base surface 18, the upper surface 19 can have be a different shape than the base surface 18. In some embodiments, the upper surface 19 of the cleaning pad may resemble a plateau, dome, peak, hill, basin, or the like. Additionally, the upper surface 19 can have different dimensions than the base surface 18. In one embodiment, the upper surface 19 has a round shape. In another embodiment, the upper surface 19 is in a rectangular shape, triangular shape, or star shape. The upper surface 19 also has an upper surface depth and upper surface width. The upper surface depth can be greater than the base surface depth. Alternatively, the upper surface depth is less than the base surface depth. Similarly, the upper surface width may be larger than the base surface width. The upper surface width may also be smaller than the base surface width.

In one embodiment, the base surface 18 expands significantly in the presence of water thereby increasing the amount of inner wheel surface contacted. In another embodiment, the base surface 18 is sufficiently rigid to provide adequate pressure when in contact with the inner wheel surface. In yet another embodiment, the base surface 18 is pre-filled with water, soap, or a cleaning agent that is released upon contact with the inner wheel surface. Similarly, the base surface 18 may contain attachment areas where pads can be attached to the base surface 18 prior to placement of the cleaning pad 10 in the wheel cavity. These pads may contain specific chemicals, cleaning agents, or scrubbing properties. These pads may also contain textured surfaces similar to those on the base surface.

FIG. 2 shows another view of a cleaning pad 20 with a modified cone configuration. In this figure, the base surface 28, or the cleaning surface 24 of the cleaning pad 20 can be seen. In this configuration, the base surface 28 has a textured surface 22, which includes a series of grooves or cutout portions forming an “X” shape. Optionally, the base surface 28 may comprise a textured surface 22 that forms a cleaning pattern that includes, bumps, grooves, ridges, cutouts, or other features. Additionally and/or alternatively, the cleaning pad 20 may include bumps, grooves, ridges, or cutouts in a checkered pattern, concentric circles, triangles, rectangles, no pattern, or any other pattern. In another embodiment, the cleaning surface 24 can include any combination of any bumps, grooves, ridges, or cutouts. A combination of these features may be arranged in a variety of patterns as described above including, but not limited to, a checkered pattern, concentric circles, triangles, rectangles, or no pattern at all.

The patterns as described may aid in cleaning functionality. When in use, the patterns present on the base surface 28 can provide varying levels of pressure on the inner wheel surface. Patterns consisting of larger ridges or bumps may apply increased pressure thereby removing hard to remove residue. Residue can include, but is not limited to, dirt, dust, debris, grime, stains, rust, oil, or any other unsightly material that can accrue on the surface of a vehicle wheel. Groove or cutout patterns present on the base surface 28 may perform a similar cleaning and residue removal function while moving across the inner wheel surface.

In one embodiment, the textured surface 22 is composed of a cleaning material that is different from the material forming the majority of the cleaning pad 20 and/or the material forming the upper surface 29 of the cleaning pad 20. For example, the textured surface material can be more rigid, abrasive, and/or stiffer than the upper surface material. Alternatively, the textured surface material can be softer or less rigid than the upper surface material. In another embodiment, the textured surface material is different from the material of both the base surface 28 and upper surface 29. The material chosen for the textured surface 22 may have a specific density, water retention ability, abrasiveness, or specialized scrubbing capabilities.

The cleaning pad 20 comprises a compressible material. This compressible material may be a foam or sponge-like material. The compressible material can be configured to compress in an axial direction that exerts an axial force to both the base surface 28 and upper surface 29 of the cleaning pad. Additionally, the compressible material can be sufficiently compressed such that it can fit between two adjacent wheel spokes when compressed while applying pressure on an inner wheel surface. In one embodiment, in an uncompressed state, the compressible material has at least one dimension that is larger than the largest distance between two adjacent spokes of a wheel. In another embodiment, the compressible material in an uncompressed state has at least one dimension that is larger than the largest distance between the inner wheel stationary mechanism and an inner wheel surface so that the material must compress in order to fit between the stationary mechanism and the inner wheel surface, but smaller than the largest distance between two adjacent spokes of a wheel, so that the pad can easily fit between the wheel spokes. The compressible material is capable of being axially compressed in response to an axial force that is less than or equal to a typical hand squeeze force. The typical hand squeeze force is a force level that is generally achievable by a typical able-bodied adult with a single hand without requiring undue exertion or strength. A person of ordinary skill in the art will understand when a compressible material has properties that require forces greater than the typical hand squeeze force to compress the material to a compressed state.

In some examples, the compressible material can include flexible polyurethane foam. For example, the compressible material can include a flexible polyurethane foam manufactured by Carpenter Co., pursuant to the product information sheet included in the appendix herein. In some examples, the compressible material has an appearance of a cellular flexible material, and a density of about 1 to about 10 pounds per cubic foot. In some examples, the compressible material will be selected to comprise a foam material that has a core density measured according to ISO 845 within the range of about 28 kg/m³ and about 32 kg/m³, for example, about 28.7 kg/m³, about 30.0 kg/m³, or about 31.5 kg/m³. In some examples, the compressible material is configured to absorb water and/or cleaning solution and to take on a waxy feel such that it becomes slippery with respect to the inner surface of the wheel when wet or saturated with water and/or cleaning solution. In some examples, the compressible material can be selected as a class 1 porous sponge, a class 2 porous sponge, a class 3 porous sponge, or with another porosity altogether depending on the particular application for the cleaning pad. The compressible material may have material properties (such as foam density, foam porosity, surface texture, etc.) that are configured to allow the pad to absorb fluids and to reduce and/or increase the friction force between the base surface of the cleaning pad and the inner surface of the wheel when the cleaning pad is wet or saturated with water and/or cleaning fluid. The compressible material may be selected to include materials that are used in other cleaning supplies, such as household sponges, brooms, mops or the like. In some examples, the compressible material is selected to include foam used as padding in seats, pillows, mattresses, safety equipment, medical equipment, and the like. In some forms, the compressible material will be selected to have a high wear and tear resistance so that the cleaning pad will be capable of repeated uses, and will not significantly deteriorate as a result of the forces and environmental factors that act on the cleaning pad during normal operation, including forces from friction, rubbing forces, snags, pulls, pokes, compression forces, stretching forces, and the like. In some examples, the compressible material will be selected to include a foam material that has a compression resistance, or compression load deflection (CLD) measured according to ISO 3386 to be within the range of about 3.2 kPa to about 4.8 kPa, for example, about 3.7 kPa, about 4.1 kPa, or about 4.5 kPa.

To install the cleaning pad 20 the user can compress the compressible material and direct it through adjacent wheel spokes into an inner wheel cavity between an inner wheel surface and inner wheel stationary mechanism. Once installed, the cleaning pad 20 expands to fill a portion of the inner wheel cavity and establish substantial contact between the base surface 28 and an inner wheel surface. The material chosen for the cleaning pad 20 may have certain shape memory capabilities that enable it to return to form after compression by the user. In one embodiment, the cleaning pad 20 returns to its original form after placement in the inner wheel cavity. In another embodiment, the cleaning pad 20 expands to a form larger than it initially was after placement in the wheel cavity. Optionally, the cleaning pad 20 may expand in the inner wheel cavity in response to a stimulus such as water, a cleaning agent, or other stimulus.

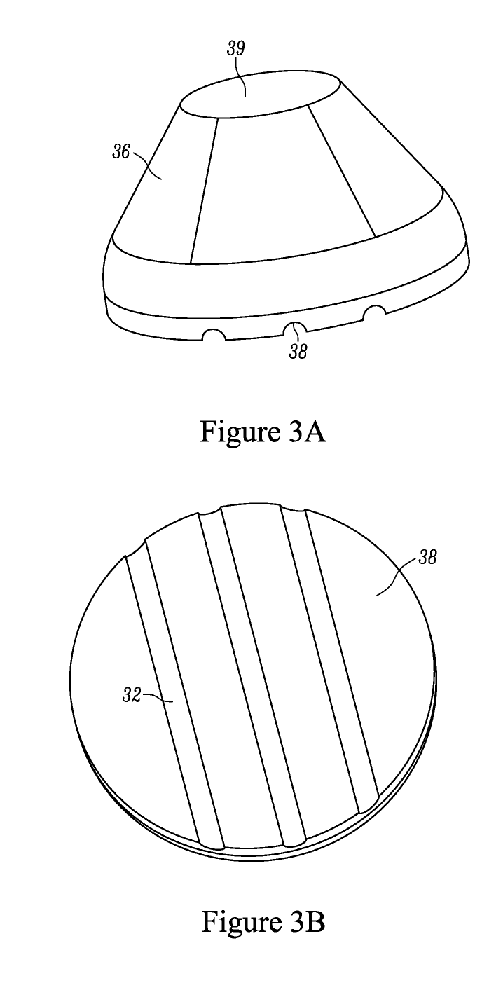

FIG. 3A shows a photograph of the modified cone or “space-ship” embodiment. As shown in this embodiment, the upper surface 39 has a smaller width than the width of the base surface 38. Thus, the tapered lateral portion 36 narrows as it extends from the base surface 38 to the upper surface 39. FIG. 3B shows the base surface 38 of a modified cone configuration with one potential textured surface pattern. In this embodiment the textured surface 32 includes a plurality of grooves and ridges oriented across the base surface 38. In another embodiment, the textured surface 32 created by the grooves or ridges could extend across substantially all of the base surface 38. Alternatively, a second plurality of grooves or ridges could be oriented perpendicular to a first plurality of grooves or ridges thereby creating another textured surface pattern.

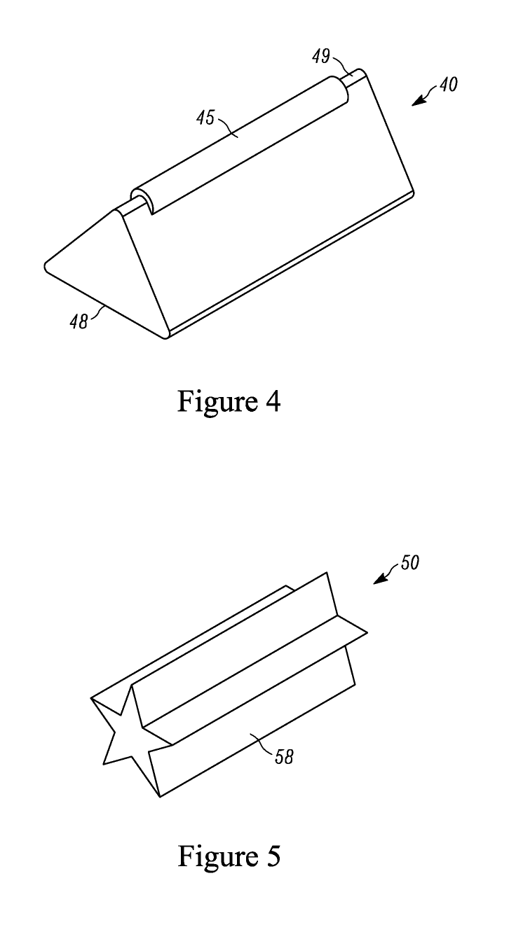

FIG. 4 shows another embodiment of the cleaning pad 40 with a rigid spine member 45. The rigid spine member 45 can serve multiple functions. In one embodiment the rigid spine member 45 assists the cleaning pad 40 in returning to form after being compressed and mounted in the wheel cavity by the user. In another embodiment, the rigid spine member 45 inhibits and/or prevents the cleaning pad 40 from being crushed while in use. The rigid spine member 45 may also serve to improve contact between the upper surface 49 and the inner wheel stationary mechanism. Additionally, the rigid spine member 45 can apply extra pressure on the base surface 48 while in contact with the inner wheel surface.

FIG. 5 shows another embodiment of the cleaning pad 50 in the shape of an elongated or extruded star. This embodiment may contain multiple base surfaces 58 located on each face of the cleaning pad. Moreover, each surface could constitute the base surface 58 or the upper surface of the pad. Additionally and/or alternatively, the base surface 58 may consist of line created by the intersection of two planes of the elongated star. In another embodiment, the elongated star rotates about a longitudinal axis through the center of the star while in use in the inner wheel cavity. In this method, multiple base surfaces contact a substantial portion of an inner wheel surface. These multiple base surfaces may be made of various materials. In one embodiment the elongated star contains one or more abrasive base surfaces while the remaining base surfaces are of a softer, less abrasive material. Additionally, the elongated star may contain a rigid spine member 55 located inside the cleaning pad. This rigid spine member 55 can help maintain the shape of the elongated star. It can also help apply pressure at the contact points between the at least one base surface 48 and inner wheel surface. The rigid star shaped cleaning pad of FIG. 5 can be installed by inserting the pad into the inner portion of a wheel, with the star-shaped end face facing away from the wheel.

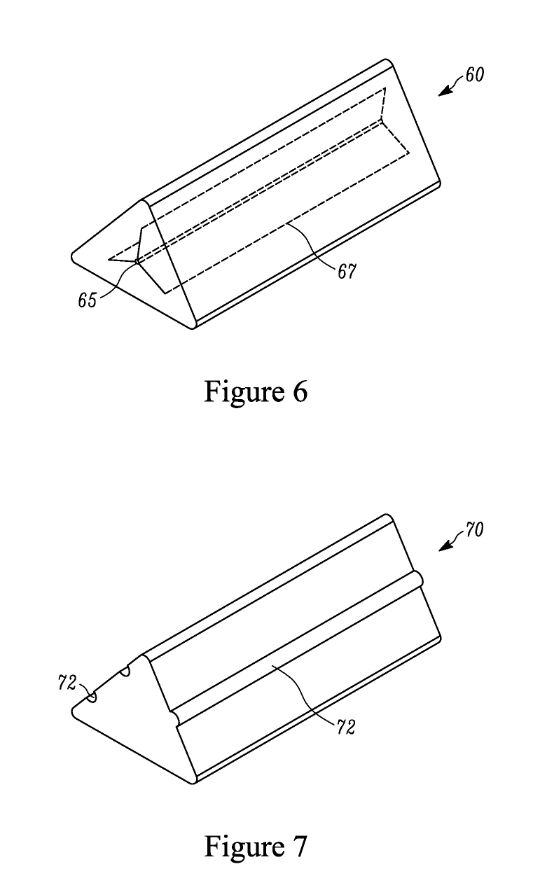

FIG. 6 shows an embodiment employing a rigid spine member 65. In this particular embodiment the rigid spine member 65 extends from a front face of the cleaning pad 60 to a rear face. The rigid spine member 65 may also contain wings 67 that increase the structural integrity of the cleaning pad, may support the cleaning pad, and also serve to apply additional pressure to the base surface in contact with the inner wheel surface. The rigid spine member 65 may be similar to the shape of the cleaning pad 60. Alternatively, the rigid spine member 65 may take on a shape different than that of the cleaning pad 60. In one embodiment the rigid spine member 65 is in the shape of a disc or cylinder. In another embodiment the rigid spine member 65 is cone shaped with the vertex oriented toward the base surface of the cleaning pad 60. The rigid spine member 65 can serve as a structural support to the cleaning pad 60. While in use, various forces may be applied to the cleaning pad 60. The rigid spine member 65 helps ensure the cleaning pad retains its structural integrity and does not tear under the stress. Additionally, the rigid spine member 65 may provide additional pressure at certain points where the base surface of the cleaning pad 60 contacts the inner wheel surface.

FIG. 7 shows yet another embodiment of a cleaning pad 70. Here, the cleaning pad 70 is in the shape of an elongated triangle. This embodiment may contain a textured surface 72 which can include, but is not limited to, ridges, bumps, grooves, or cutouts. Additionally, the textured surface 72 can contain ridges, bumps, grooves, or cutouts arranged in patterns including a checkered pattern, concentric circles, triangles, rectangles, or any other pattern.

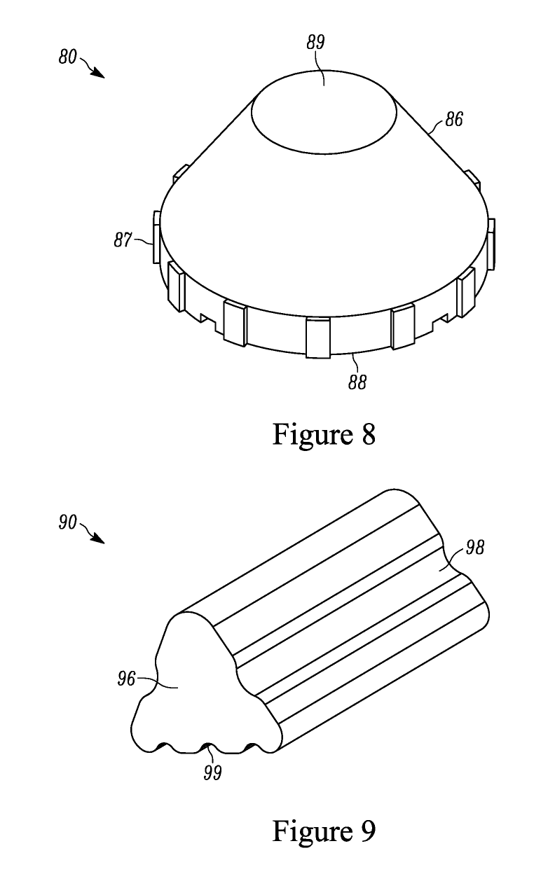

FIG. 8 shows another exemplary embodiment of the cleaning pad 80. Here, elongated protrusions 87 are found on a bottom rim of the tapered lateral portion 86 between the upper surface 89 and base surface 88 of the cleaning pad 80. Once the cleaning pad 80 is placed in the wheel cavity and the wheel begins to rotate, the base surface 88 scrubs the inner wheel surface. During rotation, the spokes of a wheel may contact the tapered lateral portion 86 of the cleaning pad. In some instances, this contact can induce rotational motion around a central vertical axis of the cleaning pad 80. This rotation of the cleaning pad 80 introduces another cleaning method that is transverse to the initial cleaning method. The elongated protrusions 87 present in this embodiment increase the incidence of contact with wheel spokes. This can result in increased rotation of the cleaning pad and thus increased cleaning capabilities. Rotation of the cleaning pad coupled with rotation of the wheels can facilitate a two-fold cleaning process resulting in the removal of more residue.

FIGS. 9-12 show other examples of cleaning pad configurations that can be used in connection with the present technology. FIG. 9 shows a cleaning pad 90 with an elongated triangle configuration with grooves located on multiple surfaces. The cleaning pad 90 has two pseudo-triangular shaped surfaces 96 extruded lengthwise to establish a cleaning pad 90 depth. The pseudo-triangular shape includes rounded corners on the bottom of the triangular face, which can help the cleaning pad 90 avoid catching or snagging on objects that rotate with the wheel upon installation. The cleaning pad 90 forms multiple base surfaces with varying groove or ridge patterns. In one example, the base surface 99 has a plurality of ridges and grooves configured to aid in removal of residue. In other examples, the base surface 98 can have a lone groove which can assist in residue removal. Alternatively, the lone groove may aid in securing the cleaning pad 90 to the inner wheel stationary mechanism while the cleaning pad 90 is in use. Further, the lone groove may help the cleaning pad 90 deform in a particular manner so that the surface 99 can more easily contour to correspond to the shape of the inner wheel surface. A variation of the configuration shown in FIG. 9 could contain a plurality of ridge or groove patterns located on more than one base surface of the cleaning pad. Additionally, these ridge or groove patterns located on multiple base surfaces may all be the same pattern or may all be substantially different patterns.

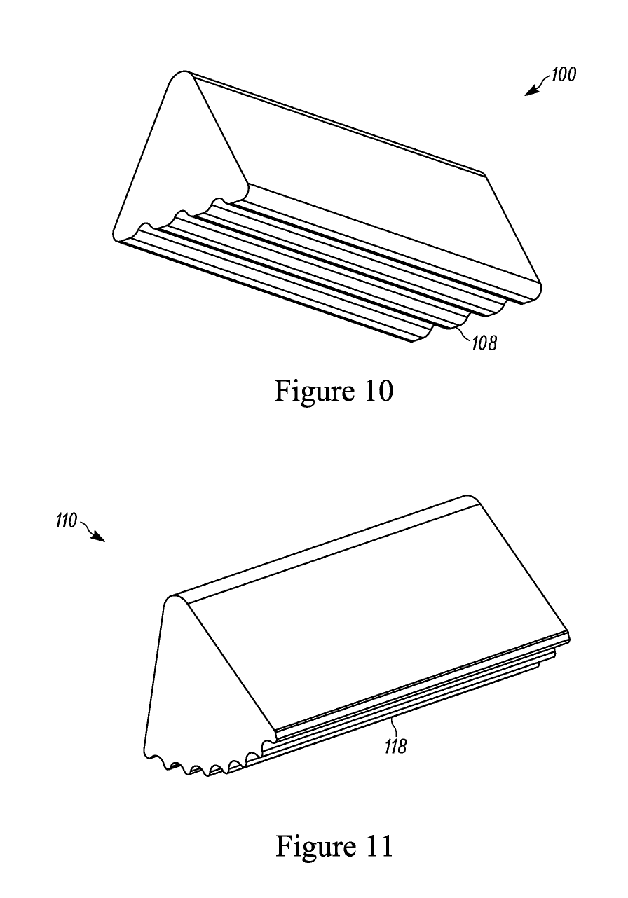

FIG. 10 shows another possible elongated triangle configuration for a cleaning pad 100. This embodiment includes one potential groove pattern located on a lone base surface 108. Alternatively, this embodiment could include multiple base surfaces with various groove or ridge patterns. These ridge or groove patterns may be similar to those located on adjacent faces of the same cleaning pad, or may substantially differ from all other patterns on the same cleaning pad, depending on the design and intended use of the cleaning pad.

FIG. 11 details the elongated pie-shaped configuration. The embodiment shown in FIG. 11 contains another potential pattern located on the base surface 118. In this particular configuration, the base surface extends outwardly from the cleaning pad 110. This may enhance cleaning capabilities and enable the base surface 118 of the cleaning pad to contact a larger portion of the inner wheel surface. In another embodiment, the-pie shaped configuration of the cleaning pad may contain more than one outwardly extending base surface. This additional outward extending base surface may have the same ridge or groove pattern as the initial outwardly extending surface. Alternatively, the additional outward extending base surface may contain a pattern substantially different from the initial base surface.

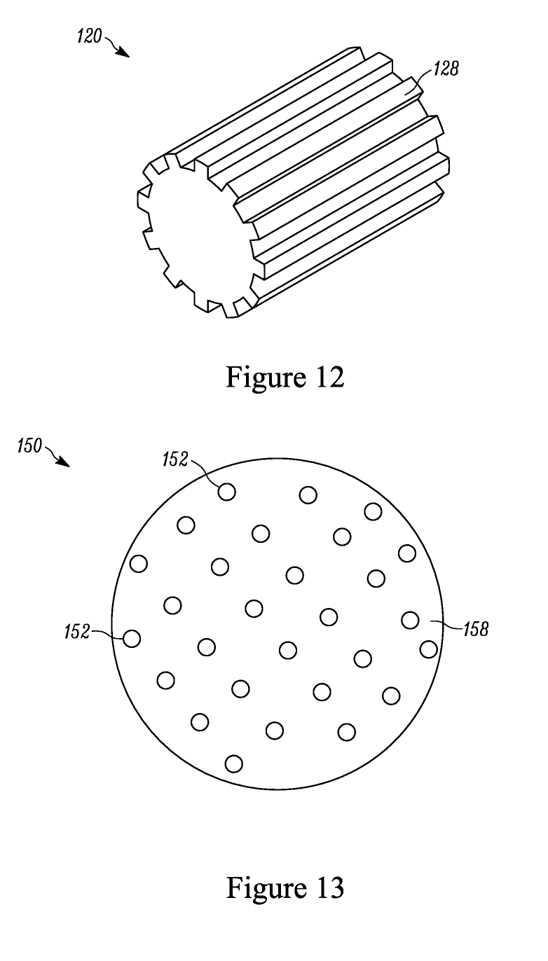

FIG. 12 illustrates an elongated gear-shaped configuration. This potential embodiment has a ridge and groove pattern 128 located on the perimeter surface of the cleaning pad 120 allowing it to scrub an inner wheel surface in any orientation. The pattern shown in this embodiment may be modified depending on the inner wheel surface to be cleaned. In another embodiment, the pattern can include various sizes of ridges, bumps, grooves, or cutouts. Additionally, the perimeter of the gear-shaped configuration may contain variations in width and/or height along the length and perimeter of the cleaning pad.

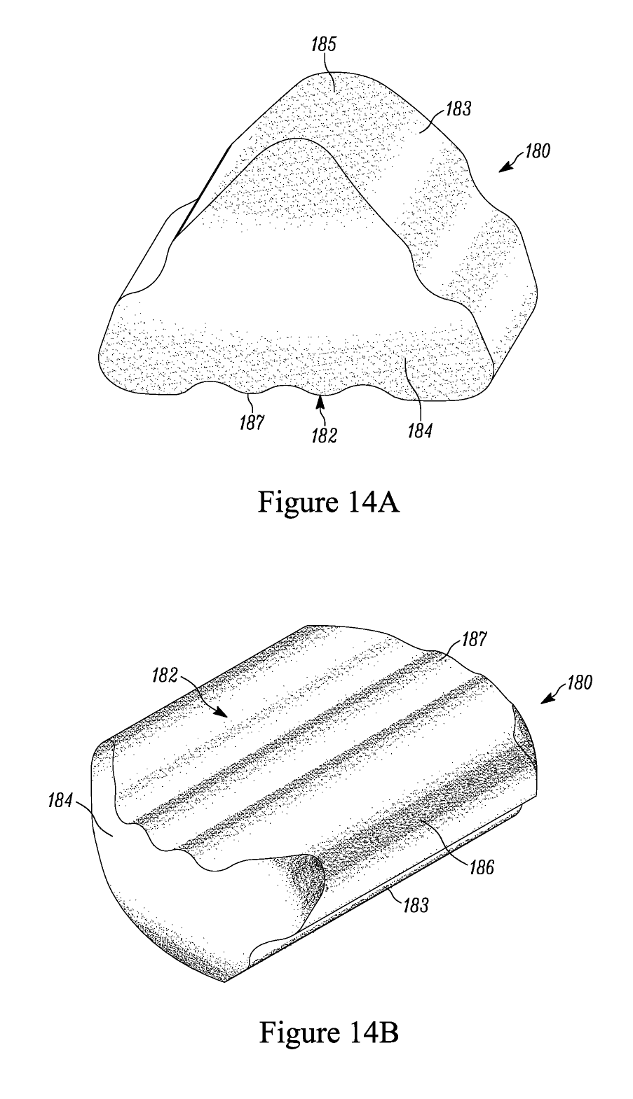

FIGS. 14A-B and 15A-B show other configurations of another cleaning pad configuration. FIGS. 14A-B and 15A-B show various views of the cleaning pads described and depicted in U.S. Design patent application No. 29/581,289, which is whereby incorporated by reference in its entirety. It should be noted that, while this application describes various aspects of the embodiments shown in FIGS. 14A-B and 15A-B in functional terms, these embodiments also include a number of ornamental features that do not have functional aspects. Moreover, it should also be understood that some of the functional aspects of these embodiments could also be achieved by features that take on another different ornamental appearance.

In the configuration of FIGS. 14A-B, the cleaning pad 180 has a pseudo-triangular shaped front surface 184. This surface 184 is curved or rounded in the lengthwise dimension of the cleaning pad, and forms a convex surface such that the upper and side edges of the cleaning pad are closer to the center of the pad than at the ends of the pad.

FIG. 14A provides an isometric view of the top front right of a cleaning pad 180, and FIG. 14B shows an isometric view that shows the base surface 182 or lower-most surface of the cleaning pad 180. The cleaning pad has a top portion or upper surface 185 that forms a nose, or rounded point. This point is configured to engage with a stationary element of a vehicle. The cleaning pad 180 has tapered side surfaces, or side edges 183 that extend from the upper surface 185 toward an opposing lower edge 186 or corner of the base surface 182 of the pad 180. The base surface 182 may be ridged or textured, for example, it may include ridges 187, bumps, pleats, or grooves, which can be used to facilitate cleaning, and to help with the compressibility of the pad for installation with respect to a wheel. In some examples, the base surface 182 may also be slightly concave, with the bottom edges 186 extending lower than the other portions of the lower surface 182, which can help to provide stability to the cleaning pad 180 as it is used to clean a wheel surface. This concave structure, with the bottom edges 186 lower than the central portion of the base surface 182 also helps reduce the point contact in the center of the pad 180 once it is installed with respect to the wheel, which can reduce friction forces between the pad and the wheel, and inhibit the cleaning pad from rolling or rotating along with the wheel as the wheel itself rotates. In this way, the base surface 182 of the cleaning pad 180 can provide an evenly distributed pressure against the inner surface of the wheel, while maintaining a relatively slippery, or low friction engagement that provides good, optimal, or near optimal cleaning ability. That is, the concave structure allows the base surface 182 to apply a more even pressure across the entirety of the surface without generating point concentration forces to the central portion of the base surface 182 that result from the compression force applied on the upper surface 185 of the cleaning pad 180 when the pad 180 is installed relative to a wheel.

Because the front surface 184 of the cleaning pad 180 forms a pseudo-triangular shape, the width upper surface 185 or the nose of the cleaning pad 180 is generally smaller than that of the base surface 182. In this way, that the tapered lateral portion 183 of the pad 180 will angle such that the width of the pad 180 narrows between the base surface 182 and the upper surface 185. The depth of the cleaning pad 180 generally has an extruded appearance, such that the cross section of the pad 180 remains generally consistent between the two opposing surfaces 184 of the pad.

The upper surface 185 or nose may be adapted to attach or grab to an inner wheel stationary mechanism to secure the cleaning pad 180 as the wheel rotates. That is, the narrowed nose shape of the upper surface 185 may be configured to engage with a stationary mechanism of a vehicle wheel, such as a brake caliper or dust shield. This configuration with a narrow upper surface and a wider base surface can facilitate the cleaning pad to remain in place with respect to the stationary mechanism, while allowing the base surface 182 to apply a cleaning pressure to the inner surface of the wheel as the wheel rotates. As shown in FIG. 14A, the upper surface 185 or nose is not a flat surface, and instead takes on a rounded nose type configuration. However, in other embodiments, the upper surface may be a straight edge, a flat surface, a beveled edge, a grooved surface, or a number of other configurations.

The cleaning pad 180 includes a tapered lateral surface 183 extending along an extruded length of the cleaning pad 180. The tapered lateral surface 183 can have grooves or ridges that facilitate in the cleaning of the cleaning pad, or that can be used to facilitate the base surface 182 forming a shape suitable for cleaning an inner wheel surface. That is, the shape of the tapered lateral surface 183 may be configured to allow the base surface 182 of a cleaning pad 180 installed in a wheel to contort into a shape that applies even pressure to the inner surface of the wheel. In some examples, the shape of the lateral surface 183 can be configured to make the cleaning pad 180 more ergonomically comfortable to operate. For instance, the cleaning pad 180 may include a gripping portion that includes the upper surface 185 and is defined by one or more recesses or grooves in the tapered lateral surfaces 180, as shown in FIGS. 14A and B. The gripping portion can make the cleaning pad easier to grab and hold for use when cleaning other portions of the wheel or vehicle. That is, the cleaning pad 180 can be designed so that it can be easily grasped via the upper surface 185, and the lower surface 182 can be used to clean all portions of a vehicle (or any other object that can be cleaned).

The front surface 184 and the opposing rear surface can also have a shape that, in two dimensions, takes on a pseudo-triangular configuration. In some forms, the shape of the front surface 184 may correspond generally to the cleaning pad 90 of FIG. 9, where the lower edges 186 of the cleaning pad 180 are rounded. This rounded structure of the lower edges 186 helps to reduce, inhibit, or prevent the base surface 182 of the cleaning pad 180 from catching or snagging on other objects that move with the wheel as it rotates. Additionally, as noted above, the front and rear surfaces 184 of the cleaning pad 180 may not be flat and form a rounded or convex shape. This provides a cleaning pad that has a generally oblong shape when viewed from a side. The convex shape can also be seen in the incorporated figures of U.S. Design patent application No. 29/581,289. The convex shape can help the cleaning pad 180 remain in place in the installed position when used to clean the wheel, as the shape helps inhibit the pad from catching or snagging on objects (e.g., spokes, valves stems, other bumps and protrusions, etc.) that rotate with the wheel. That is, by forming a convex surface, objects and protrusions rotating with the wheel that might otherwise snag on a sharp edge of a cleaning pad may be more likely to deflect and avoid snagging due to the curved convex surface of the pad 180.

The cleaning pad 180 may be formed of a compressible material, such as a foam or sponge material. The compressible material may have a surface texture configured to enable smooth sliding along the inner surface of a wheel despite the pressure exerted by the base surface 182 upon installation. In some forms, the compressible material is configured to take on a waxy feel, or to otherwise create a slippery surface upon exposure or immersion in a fluid such as water and/or a cleaning solution/detergent.

The cleaning pad 180 of FIGS. 14A-B can vary in size depending on the specific features of the vehicle wheel or wheels that it is intended to operate with. In general, the size, shape, and compressibility of the cleaning pad 180 is such that the pad 180 will be compressed to fit between the stationary mechanism and inner wheel surface. Typically, the cleaning pad 180 will have a size from the base surface 182 to the upper surface 185 that would not fit between the inner surface of the wheel and the stationary mechanism without being compressed. That is, the height of the cleaning pad 180 will be greater than the distance between the inner surface of the wheel and the stationary mechanism. The pad will also be configured so that, when it is compressed and installed with respect to the wheel, the upper surface 185 of the cleaning pad 180 will exert an upward force, (or radially inward with respect to the wheel) sufficient to allow the upper surface or nose of the cleaning pad presses against the stationary mechanism, thereby fixing the pad 180 in place with respect to the wheel as the wheel rotates during normal operation. The base surface 182 of the cleaning pad 180 is configured with a size and shape sufficient to provide adequate coverage of the inner wheel surface such that the cleaning pad 180 can sufficiently clean a majority, or even an entirety of that inner wheel surface. The size of the cleaning pad is also configured so that the base surface exerts an opposing force against the inner wheel surface sufficient to clean that surface. The cleaning pad is configured so that it can be squeezed to fit in between the spokes of a vehicle wheel, without requiring significant squeezing force on the part of a user. In some examples, the cleaning pad may have a width (e.g., extending from the bottom left to bottom right corner of the front surface 184 of the cleaning pad) of about 4 to about 8 inches, or more particularly, between about 5 and about 7 inches, or even more specifically, about 6 inches. The cleaning pad may have a height (e.g., extending from the base surface 182 to the upper surface 185) of about 2 to about 6 inches, or more particularly between about 3 to about 5 inches, or even more specifically, about 4 inches. The cleaning pad 180 may also have a depth of between about 6 to about 10 inches, more particularly between about 7 to about 9 inches, or even more specifically, about 8 inches.

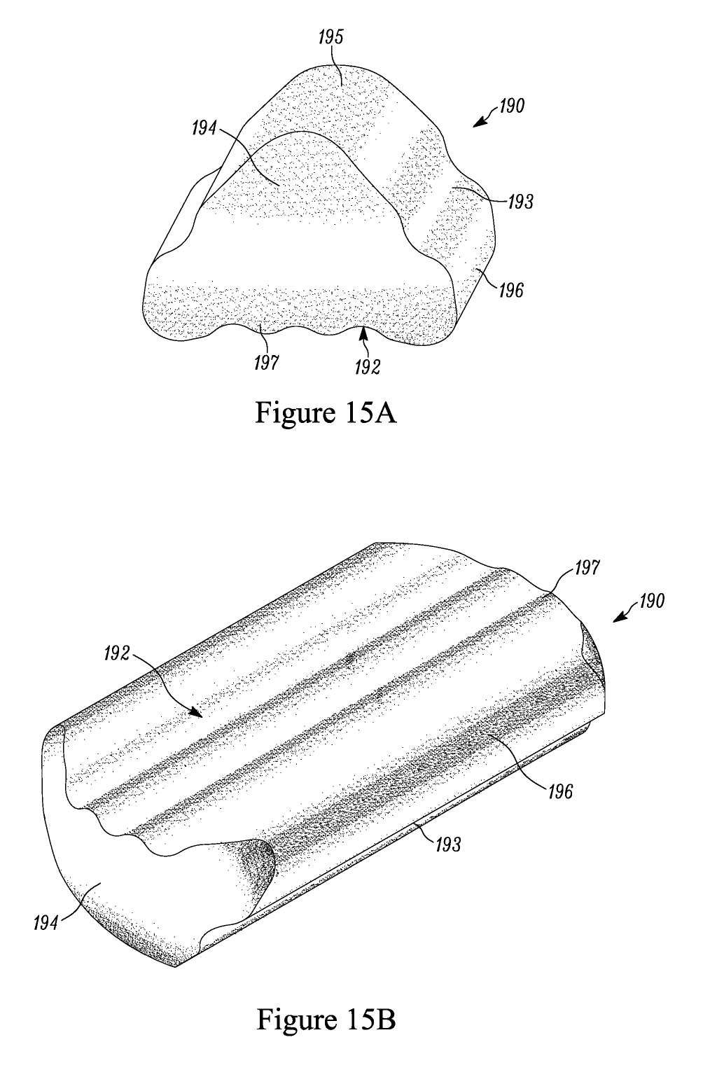

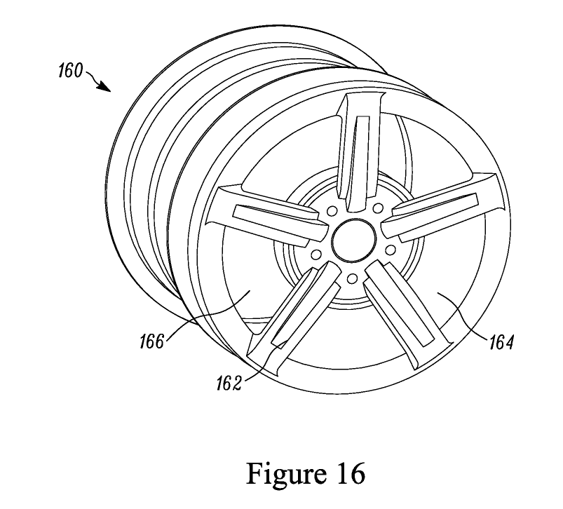

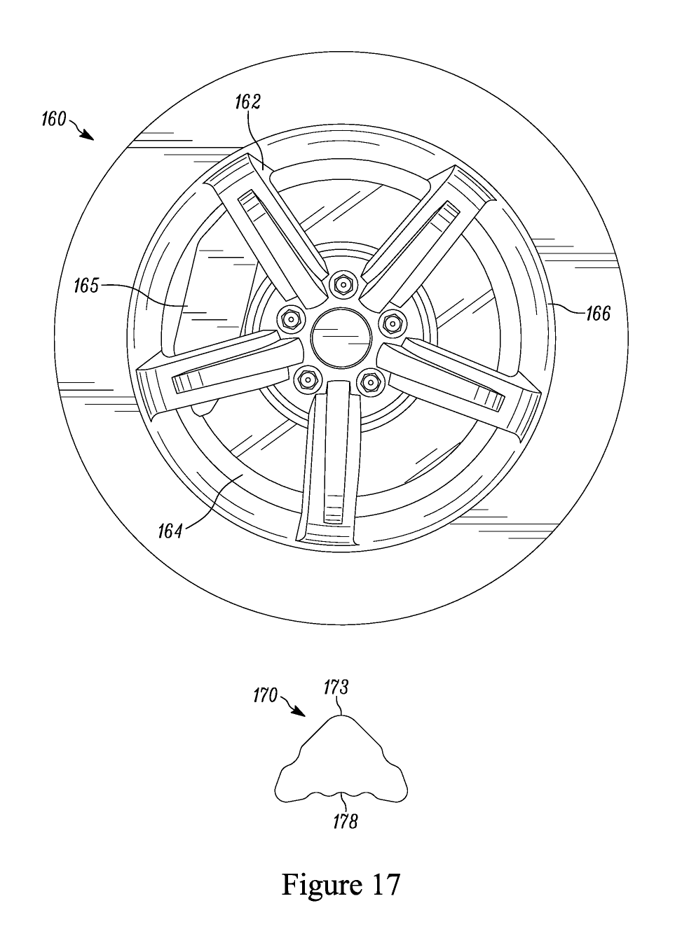

FIGS. 15A and B show a cleaning pad 190 that is similar to the cleaning pad 180 of FIGS. 14A and B, with a tapered lateral edge 193 extending between an upper surface 195 and a lower edge 196 or corner. The bottom surface 192 of the pad 190 includes ridges 197 to assist in compressing the pad 190 and also to provide texture to facilitate cleaning of an inner wheel surface. The cleaning pad 190 is similar in structure to the pad 180 of FIGS. 14A and B, and the depth of the cleaning pad, namely, the length of the pad 190 between the front surface 194 and the opposing surface may be generally the same as that of the cleaning pad 180 of FIGS. 14A and B (e.g., between about 6 to about 10 inches, or more specifically, about 8 inches). However, cleaning pad 190 generally has a smaller front face 194 than the front face 184 of cleaning pad 180 of FIGS. 14A and B. In this way, cleaning pad 190 may be preferable to use in connection with wheels that have less space between spokes. In some examples, the cleaning pad may have a width (e.g., extending from the bottom left to bottom right corner of the front surface 194 of the cleaning pad) of about 3 to about 6 inches, or more particularly, between about 4 and about 5 inches, or even more specifically, about 4.5 inches. The cleaning pad may have a height (e.g., extending from the bottom surface 192 to the upper surface 195) of about 1.5 to about 3.5 inches, or more particularly between about 2 to about 3 inches, or even more specifically, about 2.5 inches.

As described herein, the cleaning pad can take on a variety of shapes, sizes, and configurations based on the intended use. U.S. Provisional Patent Application No. 62/245,418 (“the '418 Provisional”), including the associated Appendix, includes various figures, sketches, and photographs of cleaning pads and uses of cleaning pads that are hereby incorporated by reference in its entirety. As shown in the include cleaning pads in various pie-shaped and triangle shaped configurations. Additionally, there is shown a cylindrically-shaped configuration containing no ridges or grooves on its perimeter. However, one skilled in the art would understand that ridges and/or grooves may be added to a surface of the cylindrically-shaped cleaning pad.

FIG. 13 shows the textured surface 152 of a cleaning pad 150 that has a round base surface 158. The cleaning pad 150 in this embodiment may have a modified cone shape configuration, a cylindrical configuration, or another configuration. This embodiment contains a series of bumps, protrusions, or other textured features 152 that provide textured pattern on the base surface 158. A pattern as shown in this embodiment can help remove stubborn residue over a large portion of an inner wheel surface. In another embodiment the pattern varies across the texted surface of the cleaning pad. In yet another embodiment, the ridges and grooves are composed of a different material with special water absorbency, abrasive, or scrubbing capabilities.

In some forms, the base surface of a cleaning pad is composed of a material different from that of the upper surface. For example, the base surface may comprise an abrasive material, such as an abrasive scrubbing pad, brush material, metallic material such as steel wool, sandpaper, or a smoother material, for example, for buffing purposes.

FIG. 16 shows an example of a vehicle wheel 160 with an inner wheel surface that 164 can be cleaned by one or more examples of the cleaning pads described herein. As shown, the wheel 160 has a number of structural members or spokes 162 that define wheel cavities 166. The inner wheel surface 164 is positioned around the outer rim of the inner wheel. The wheel 160 also has an inner wheel stationary mechanism 165 which generally remains stationary as the wheel rotates. The inner wheel stationary mechanism 165 can include elements of the brake assembly including but not limited to a brake caliper, a dust shield, or other similar structures. Additionally, the inner wheel stationary mechanism 165 can include components attached to or near the vehicle wheel axle. The stationary mechanism 165 may include a deviation portion that can include a protrusion an indentation, or other object that remains in a stationary position with respect to the wheel inner wheel surface 164 as the wheel rotates. The inner wheel stationary mechanism 165 helps hold the cleaning pad in place as the wheel rotates, thereby facilitating the cleaning pad to scrub or otherwise clean the inner wheel surface 164.

FIG. 17 shows a cleaning pad 170 prior to installation in the wheel cavity 167. In this embodiment, the base surface 178 of the cleaning pad 170 includes bumps, grooves, and/or ridges. This base surface 178 is arranged so that it can be placed in contact with the inner wheel surface 164 of the wheel 160. To install the cleaning pad 170, the user will compress the cleaning pad 170 such that it will fit between the spokes 162 that define the wheel cavities 166. FIG. 17 also shows an inner wheel stationary mechanism 165 such as a brake caliper, a dust shield, or other similar structures. The cleaning pad 170 can be placed into any one of the various wheel cavities 166 located on the wheel 160. The cleaning pad has an upper surface 173 that is designed to operate in connection with the stationary mechanism 165 (e.g., a deviation portion of the stationary mechanism) so that the upper surface 173 of the cleaning pad 170 remains in place with respect to the stationary mechanism 165 as the wheel 160 rotates. While in use, the upper surface 173 of the cleaning pad 170 contacts the inner wheel stationary mechanism 165 which holds the cleaning pad 170 in place or generally inhibits the cleaning pad from rotating with the wheel 160. In this way, as the wheel 160 rotates about its central axis, the upper surface 173 of the cleaning pad 170 will stay pressed against the inner wheel stationary mechanism 165, and the lower or base surface 178 can remain in contact with the inner wheel cleaning surface 164. This allows the base surface 178 of the cleaning pad 170 to contact and press against the inner wheel surface 164 as the wheel rotates, thereby allowing the cleaning pad 170 to clean the inner wheel surface 164 and remove dirt, grime, and other residue therefrom.

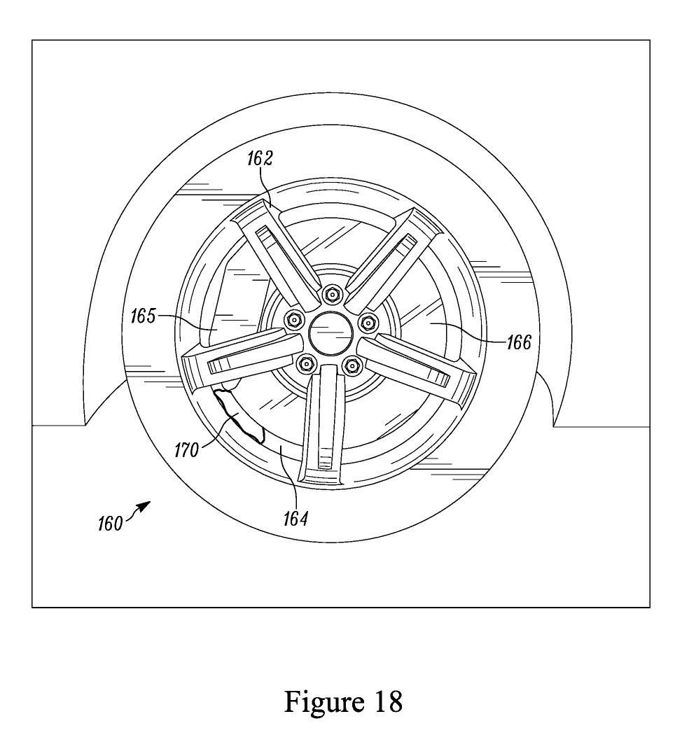

FIG. 18 shows a cleaning pad 170 installed in a wheel cavity 166. In this figure, the cleaning pad 170 has been compressed such that it fits between adjacent spokes 162 of the wheel 160. The cleaning pad 170 can be installed in any of the various wheel cavities 166. When the wheel 160 rotates, the cleaning pad 170 will rotate with the wheel 160 until the pad 170 connects with the inner wheel stationary mechanism 165. Contact with the inner wheel stationary mechanism 164 inhibits the cleaning pad 170 from further rotating about the central axis of the wheel 160 as the wheel 160 and the inner wheel surface 164 continue to rotate.

The present technology provides various examples, shapes, configurations, and embodiments of cleaning pads, in particular, cleaning pads configured for cleaning the inner wheel surface of a vehicle wheel. The vehicle wheel can have a plurality of spokes that define a plurality of wheel cavities, and a stationary mechanism that remains stationary as the vehicle wheel rotates.

In some forms, the cleaning pad includes a base surface having a base surface width and a base surface depth. In some examples, the base surface width is the width represents the dimension of the cleaning pad that lies around a portion of the circumference of the wheel when installed. Generally speaking, the width of the base surface will expand after installation to apply pressure onto the inner surface of the wheel. The depth of the base surface depth can represent the depth of the inner wheel surface (i.e., where the cleaning pad is installed).

The cleaning pad also has an upper surface with a width and depth. The upper surface width and depth can correspond to the same dimensions as the base surface width and base surface depth, but are not necessarily the same size. That is, the upper surface may have a smaller width and/or depth compared to that of the base surface.

A tapered lateral portion extends along a pad axis between the base surface and the upper surface. That is, the tapered lateral portion essentially connects the base surface and upper surface. For instance, where the cleaning pad is the shape of a cylinder, the tapered lateral portion would include the rounded portion extending between the two end surfaces of the cylinder. Where the cleaning pad is a cone or modified cone shape (or “space-ship” shape), the tapered lateral portion can include the curved surface extending between the vertex, or upper surface of the cone and the base. Where the cleaning pad is a rectangular or box shape, the tapered lateral portion may include three or more sides adjoined by edges that extend between the base and upper surfaces. In some aspects the base surface width is greater than the upper surface width so that the width of the tapered lateral portion narrows as the tapered portion extends from the base surface toward the upper surface.

In some examples, the upper surface of the cleaning pad is configured to engage with the inner wheel stationary mechanism of the vehicle wheel to hold the cleaning pad in place as the vehicle wheel rotates, and wherein the base surface is configured to engage with an inner surface of a vehicle wheel to clean the inner surface as the vehicle wheel rotates with respect to the cleaning pad.

The cleaning pad comprises a compressible material. For example, the cleaning pad can include a compressible foam material, such as a sponge. The compressible material can be configured so that it can be compressed to a compressed state, wherein the cleaning pad can fit within a wheel cavity in the compressed state. The compressible material can be configured to compress in an axial direction (that is, compressing the upper surface toward the lower surface) so that, in the axially compressed state the pad exerts an axial force toward the base surface and the upper surface. In other words, when in the axially compressed state, the cleaning pad tends to assert pressure towards its uncompressed state, thereby exerting pressure via one or both of the upper surface and the base surface.

In some examples, the cleaning pad is configured so that, in a compressed state (e.g., the axially compressed state), the pad can fit between two adjacent spokes of the wheel. This can be particularly useful where the cleaning pad has an uncompressed state that has at least one dimension that is larger than the largest distance between two adjacent spokes of the wheel. In such a configuration, the cleaning pad will not fit between adjacent spokes of the wheel unless and until the pad is at least partially compressed. In some examples, the cleaning pad will only fit between the spokes of a wheel in the axially compressed state. In other examples, the wheel spokes are spaced sufficiently apart such that the compressible material need not be compressed to pass through adjacent spokes but may need to be compressed to be placed between the inner wheel stationary mechanism and inner wheel surface. The compressible material forming the cleaning pad can be configured to compress to the axially compressed state in response to a first axial force generated on the pad, wherein the first axial force is less than or equal to a typical hand squeeze force. The typical hand squeeze force is a force level that is generally achievable by a typical able-bodied adult with a single hand without requiring undue exertion or strength. A person of ordinary skill in the art will understand when a compressible material has properties that require forces greater than the typical hand squeeze force to compress the material to a compressed state. The compressible material could also be configured so that the axial force exerted by the cleaning pad in the compressed state is sufficient to install the pad in place between the inner surface of the vehicle wheel and the inner wheel stationary mechanism. Further, the axial force exerted by the cleaning pad in the compressed state can also be sufficient to enable the base surface of the cleaning pad to remove residue from the inner surface of the vehicle wheel as the vehicle wheel rotates about the cleaning pad.

In some examples, the cleaning pad comprises a second material having at least one of a different texture or stiffness from the compressible foam material. The second material can give the first material rigidity or stiffness. The second material can be positioned about the upper surface of the cleaning pad. The second material can be configured to facilitate holding the cleaning pad in place against the inner wheel stationary mechanism. The second material can be configured to improve the structural integrity of the cleaning pad and inhibit degradation of the cleaning pad at or around the upper surface. The second material can also be positioned about the base surface of the cleaning pad, and in some examples, can include an abrasive material configured to facilitate the scrubbing properties of the base surface. For example, the abrasive material can include a scrubbing surface, a scrubbing pad, steel wool, or the like.

In some examples, the base surface of the cleaning pad comprises a textured surface to facilitate the scrubbing properties of the cleaning pad. The textured surface can include at least one of ridges, bumps, grooves, or cutouts. The textured surface can be formed in or from the compressible material, or it can include or be formed from the second material.

In some examples, the base surface of the cleaning pad has a depth greater than the depth of the upper surface. For example, the base surface and/or the upper surface can have a round shape, whereby the width/depth of the base is greater than that of the upper surface. In such an example, the cleaning pad may take on a conical configuration or a modified cone configuration (e.g., a “space-ship” configuration).

In other examples, the base surface depth and the upper surface depth are generally the same. In such an example, the base surface may form a generally rectangular shape (or cross section). Likewise, the upper surface can also take on a generally rectangular shape.

In some configurations, the cross section of the cleaning pad taken along a lateral plane (i.e., a plane that runs parallel to the outer edge of the wheel, i.e., parallel to the direction of travel of the wheel) has a generally triangular configuration. In some examples, the cross section of the cleaning pad taken along the lateral plane has a generally pie-shaped configuration.

Some aspects provide a kit for cleaning an inner surface of each of four vehicle wheels. The kit can include two or more cleaning pads as described herein, packaged together, or alongside one another. For example, one kit may include four cleaning pads described herein, each cleaning pad intended for use with one of four wheels of a vehicle. In some examples, each cleaning pad of the kit will take on the same or a similar configuration. In other examples, however, one or more cleaning pads of the kit can take on a different configuration from one or more other cleaning pads of the kit. Such use of varying cleaning pad configurations can be based on the intended use. For example, where the kit is designed to provide cleaning pads for multiple wheels that vary in shape, size, or appearance, varying cleaning pad types can be provided.

The present disclosure also provides examples of methods for making and using the cleaning pads described herein. For example, one such method can involve forming a cleaning pad from a block of compressible material (e.g., foam). Other methods relate to the use of a cleaning pad to clean the inner surface of a vehicle wheel.

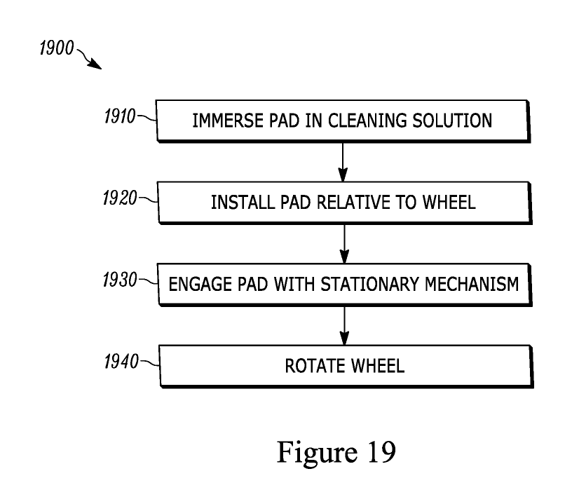

FIG. 19 is a flow diagram of a method 1900 for installing. The method includes immersing 1910 the cleaning pad in a cleaning solution. This can include dipping or submerging the pad into a bucket of soapy water, for example. In some aspects, the pad may be capable of cleaning without being immersed in a cleaning solution. For example, the pad may already be wet, or it may include a cleaning solution or composition built into the pad that facilitates cleaning by the pad.

The pad is installed 1920 relative to a wheel. The installation 1920 can be performed such that a lower or base surface of the cleaning pad engages with an inner surface of the wheel. The installation 1920 can include compressing the cleaning pad to a compressed position. For example, the cleaning pad can be compressed by squeezing the pad so as to fit the cleaning pad between the spokes of a wheel. The installation 1920 can also include inserting the compressed cleaning pad between two adjacent spokes of the vehicle wheel, and installing the cleaning pad onto the inner surface of the vehicle wheel. The installation 1920 may involve compressing the cleaning pad (e.g., in an axial dimension) such that an installed pad is in a compressed state so that the base surface of the pad exerts a force or pressure on the inner surface of the wheel, where that force or pressure facilitates cleaning of the inner wheel surface.

The installed cleaning pad can then be engaged 1930 with a stationary mechanism of the vehicle, such as a brake caliper or dust shield. The engagement 1930 is such that the upper surface of the cleaning pad is fixed in place relative to the stationary mechanism. That is, in this manner, the upper surface of the cleaning pad will not move relative to the cleaning pad, even if the wheel itself moves. The engagement can occur by rotating the wheel and allowing the cleaning pad to move with the wheel until it comes into contact with the stationary mechanism. In some situations, the cleaning pad can be initially installed so as to engage with the stationary mechanism.

Upon installation, the wheel can then be rotated 1940 in the usual manner. This rotation 1940 can involve moving the vehicle forward or backward, or in situations where the wheel is elevated, simply rotating the wheel about the axle. The method can include rotating the vehicle wheel at least one full rotation, or more than one full rotation. In this way, with the cleaning pad fixed in place relative to the stationary mechanism, the inner surface of the wheel will rub against the base surface of the cleaning pad, and the pressure from that base surface will facilitate removal of dirt, grime, debris, or dirt in general from the surface.

In some aspects, the method includes performing the same steps relative to another wheel, or other wheels on the vehicle. That is, the method can include installing a second cleaning pad with respect to a second wheel on the vehicle such that an upper surface of the second cleaning pad engages with a stationary mechanism and a base surface of the second cleaning pad engages with the inner surface of the second wheel, wherein the installing the second cleaning pad fixes the upper surface of the cleaning pad in a position relative to the stationary mechanism.

As discussed above, the cleaning pad can be used to clean tires. Alternatively, the cleaning pad can also be used to perform various other services including waxing or buffing. In one example, a waxing or buffing agent may be applied to the base surface or textured surface of the cleaning pad. The cleaning pad is then placed in the inner wheel cavity between the inner wheel stationary mechanism and the inner wheel surface. The vehicle can then operate forward or backward to perform a waxing or buffing service to the inner wheel surface. In another example, an additional cleaning pad is placed in the inner wheel cavity after the waxing process to help spread the waxing or buffing agent about the inner wheel surface. In yet another example, the cleaning pad can serve as a whole vehicle body exterior surface cleaning, waxing, or buffing pad.

The present disclosure describes preferred embodiments and examples of cleaning pads and their methods of use. Those skilled in the art will recognize that a wide variety of modifications, alterations, and combinations can be made with respect to the above described embodiments without departing from the scope of the invention as set forth in the claims, and that such modifications, alterations, and combinations are to be viewed as being within the ambit of the inventive concept. In addition, it should also be understood that features of one embodiment may be combined with features of other embodiments to provide yet other embodiments as desired. All references cited in the present disclosure are hereby incorporated by reference in their entirety.

1. A cleaning pad for an inner surface of a wheel on a vehicle, the vehicle having a stationary mechanism that remains stationary relative to the inner surface of the wheel as the wheel rotates, the cleaning pad comprising a compressible material and forming a base surface, an upper surface opposite the base surface, and a lateral portion extending between the base surface and the upper surface,
wherein the cleaning pad is configured to be installed relative to the wheel so that the base surface engages with the inner surface of the wheel, so that the upper surface engages with the with the stationary mechanism, and so that upper surface of the cleaning pad remains in a fixed position relative to the stationary mechanism as the wheel rotates.

2. The cleaning pad of claim 1, wherein the compressible material is configured to compress in an axial direction so that the base surface of the cleaning pad, upon installation, exerts an axial force on the inner surface of the wheel, and wherein the cleaning pad is configured so that, upon installation, the base surface remains flush against the inner surface of the wheel, so that the axial force is sufficient to cause the base surface to exerts a pressure against the inner surface of the vehicle wheel sufficient to clean the inner surface as the vehicle wheel rotates, and so that the upper surface of the cleaning pad remains engaged with the stationary mechanism as the wheel rotates relative to the cleaning pad.

3. The cleaning pad of claim 1, wherein the cleaning pad has a width along the base surface and a width along the upper surface, wherein the width along the base surface is greater the width along the upper surface width so that a width of the cleaning pad along the lateral portion narrows between the base surface and the upper surface.

4. The cleaning pad of claim 3, wherein the cleaning pad comprises front and back surfaces adjacent the upper surface, the base surface, and the lateral portion, wherein the front and back surfaces have rounded opposing lower corners.

5. The cleaning pad of claim 4, wherein at least a portion of at least one of the front and back surfaces forms a convex shape.

6. The cleaning pad of claim 4 wherein the base surface forms a concave shape configured to reduce the friction force on a central portion of the base surface in response to the cleaning pad being compressed in an axial direction while the base surface is engaged with the inner surface of the wheel.

7. The cleaning pad of claim 1, wherein the cleaning pad comprises a second material in addition to the compressible material, the second material having at least one of a different texture and stiffness from the compressible foam material.

8. The cleaning pad of claim 7, wherein the second material is positioned about the upper surface of the cleaning pad, and wherein the second material is configured to facilitate holding the cleaning pad in place against the inner wheel stationary mechanism and to inhibit degradation of the upper surface of the cleaning pad.

9. The cleaning pad of claim 7, wherein the second material is positioned about the base surface of the cleaning pad, and wherein the second material comprises an abrasive material configured to facilitate the scrubbing properties of the base surface.

10. The cleaning pad of claim 1, wherein the wheel has a plurality of spokes evenly spaced apart from one another such that the spokes are spaced by a maximum spacing distance at an axial perimeter of the wheel, wherein cleaning pad, in an uncompressed state, has a size that is larger in every dimension than the maximum spacing distance such that the cleaning pad cannot fit between any two adjacent spokes in an uncompressed state, and wherein the compressible material is configured such that the cleaning pad can be compressed to fit between the spokes of the wheel.

11. A kit comprising a package and plurality of the cleaning pads of claim 1 within the package.

12. The kit of claim 11, wherein the kit comprises four cleaning pads.

13. The kit of claim 12, wherein each of the cleaning pads corresponds to a different wheel when on a vehicle.

14. A cleaning pad that cleans an inner surface of a vehicle wheel, the vehicle having an inner wheel stationary mechanism that remains stationary relative to the vehicle wheel as the vehicle wheel rotates, the cleaning pad comprising:
a base surface configured to clean the inner surface of the vehicle wheel, the base surface having base surface width and forming a concave shape;
an upper surface having an upper surface width that is narrower than the base surface width; and
opposing front and rear surfaces adjacent the base surface and the upper surface, the opposing front and rear surfaces each having rounded opposing lower corners that correspond with the base surface, and a rounded upper corner that corresponds with the upper surface, the opposing front and rear surfaces forming a convex shape,
wherein the cleaning pad comprises a compressible material, and wherein the cleaning pad is configured be installed with respect to the wheel so that the upper surface of the cleaning pad engages with the stationary mechanism, so that so that the stationary mechanism holds the cleaning pad in a fixed position relative to the inner surface as the vehicle wheel rotates, and so that the compressible material causes the base surface to exert an axial force on the inner surface of the vehicle wheel as the vehicle wheel rotates relative to the cleaning pad.

15. A method of cleaning an inner surface of a wheel on a vehicle comprising:
installing a cleaning pad formed from a compressible material with respect to the wheel so that an upper surface of the cleaning pad engages with a stationary mechanism and a base surface of the cleaning pad engages with the inner surface of the wheel, wherein the installing fixes the upper surface of the cleaning pad in a position relative to the stationary mechanism; and
operating the vehicle to rotate the wheel about the cleaning pad.

16. The method of claim 15, wherein the installing further comprises compressing the cleaning pad in an axial dimension such that base surface of the cleaning pad exerts an axial force on the inner surface of the wheel upon installation.

17. The method of claim 15, further comprising immersing a cleaning pad in a cleaning solution prior to installing the cleaning pad.

18. The method of claim 15, wherein the operating the vehicle includes rotating the vehicle wheel at least one full rotation.

19. The method of claim 15, further comprising installing a second cleaning pad with respect to a second wheel on the vehicle such that an upper surface of the second cleaning pad engages with a stationary mechanism and a base surface of the second cleaning pad engages with the inner surface of the second wheel, wherein the installing the second cleaning pad fixes the upper surface of the cleaning pad in a position relative to the stationary mechanism.

20. The method of claim 15, wherein the base surface of the cleaning pad has a larger surface area than the upper surface of the cleaning pad, and having a width less than that of the base surface, wherein the cleaning pad is formed from a compressible material, and wherein the installation comprises compressing the cleaning pad in an axial dimension such that the base surface remains flush against the inner surface of the wheel and exerts an axial pressure on the inner surface, wherein the axial pressure is sufficient to clean the inner surface as the vehicle wheel rotates, and wherein the axial force is sufficient to allow the upper surface of the cleaning pad to remain engaged with the stationary mechanism as the wheel rotates relative to the cleaning pad.
